(19) United States
(12) Patent Application Publication
(10) Pub. No.: US 2026/0070429 A1
(43) Pub. Date: Mar. 12, 2026

(54) CONTROLLER FOR ELECTRIC VEHICLE AND METHOD FOR CONTROLLING ELECTRIC VEHICLE

(71) Applicant: KAWASAKI MOTORS, LTD., Akashi-shi (JP)

(72) Inventors: Keita KATO, Akashi-shi (JP); Koki OGAHARA, Akashi-shi (JP)

(73) Assignee: KAWASAKI MOTORS, LTD., Akashi-shi (JP)

(21) Appl. No.: 19/322,708

(22) Filed: Sep. 9, 2025

(30) Foreign Application Priority Data
Sep. 10, 2024 (JP) 2024-156940

(51) Int. Cl. B60L 50/60; B60L 7/18; B60L 58/12; B60L 58/18

(52) U.S. Cl. CPC B60L 50/60; B60L 7/18; B60L 58/12; B60L 58/18; B60L 2240/429; B60L 2250/16

(57) ABSTRACT

To perform control over a motor responsive to a number of batteries, a controller for an electric vehicle includes a processor that determines a number of one or more first batteries and changes control over the motor electrically connected to the one or more first batteries based on the determined number.

### CROSS-REFERENCE TO RELATED APPLICATION

This application claims priority to Japanese Patent Application No. 2024-156940 filed on Sep. 10, 2024, the disclosure of which including the specification, the drawings, and the claims is hereby incorporated by reference in its entirety.

### BACKGROUND

### Technical Field

The present disclosure relates to a controller for an electric vehicle and a method for controlling an electric vehicle.

### Description of the Background

A known controller for an electric vehicle controls the motor output. For example, Japanese Unexamined Patent Application Publication No. 2000-253588 describes a controller for an electric vehicle that performs control responsive to the type of a battery installed in the electric vehicle. More specifically, the controller for an electric vehicle determines the type of the battery, selects discharge data corresponding to the battery type, and controls discharge of the battery based on the discharge data to control the output of the motor connected to the battery.

### BRIEF SUMMARY

The controller for an electric vehicle described above performs control without being responsive to the number of batteries of the same type installed in the vehicle.

One or more aspects of the present disclosure are directed to control over a motor responsive to the number of batteries.

A controller for an electric vehicle according to an aspect of the present disclosure includes a processor that determines a number of one or more first batteries, and changes control over a motor electrically connected to the one or more first batteries based on the determined number.

A method for controlling an electric vehicle according to another aspect of the present disclosure includes determining a number of one or more first batteries, and changing control over a motor electrically connected to the one or more first batteries based on the determined number.

The controller for an electric vehicle and the method for controlling an electric vehicle allow control over the motor responsive to the number of batteries.

### BRIEF DESCRIPTION OF DRAWINGS

FIG. 1 is a schematic diagram of an electric vehicle including a controller for an electric vehicle according to an embodiment.

FIG. 2 is a block diagram of the controller for an electric vehicle, first batteries, and a motor.

FIG. 3 is a block diagram of a second battery.

FIG. 4 is a flowchart of processing performed by the controller for an electric vehicle.

### DETAILED DESCRIPTION

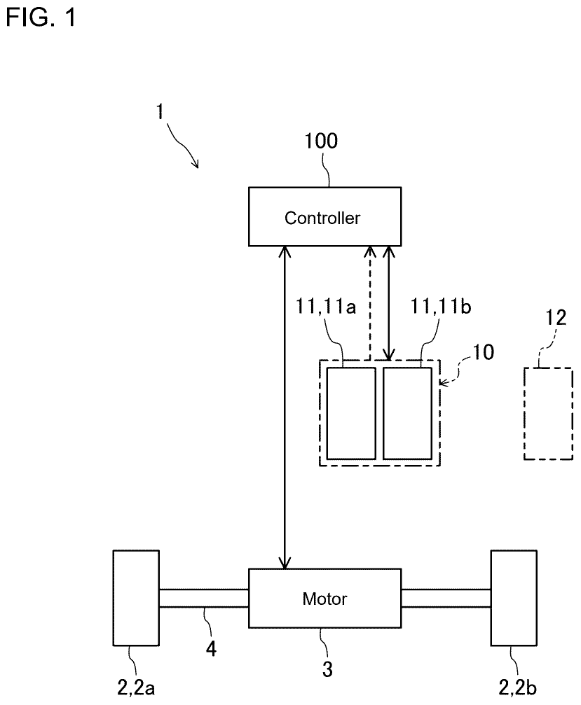

Exemplary embodiments will now be described in detail with reference to the drawings. FIG. 1 is a schematic diagram of an electric vehicle 1 including a controller 100 for an electric vehicle according to an embodiment. The electric vehicle 1 includes a motor 3, a battery array 10, and the controller 100 for an electric vehicle. The controller 100 for an electric vehicle is hereafter also simply referred to as the controller 100.

The electric vehicle 1 further includes wheels 2 and a drive shaft 4. The wheels 2 include left and right wheels 2a and 2b. The electric vehicle 1 is an electric automobile including the motor 3 to drive the left and right wheels 2a and 2b. The electric vehicle 1 includes the motor 3 as a drive that drives the drive shaft 4 to rotate the left and right wheels 2a and 2b. The left and right wheels 2a and 2b drivable by the motor 3 are at least either front wheels or rear wheels. The motor 3 may drive the drive shaft 4 either directly or through a reducer or a transmission.

The motor 3 is electrically connected to the battery array 10. The motor 3 functions as, for example, an electric motor and a power generator. As an electric motor, the motor 3 generates a drive force using electric power supplied from the battery array 10 and rotates the drive shaft 4 and the left and right wheels 2a and 2b to drive the electric vehicle 1. As a power generator, the motor 3 generates electric power using a drive force input from the drive shaft 4 to supply electric power to the battery array 10. When, for example, the electric vehicle 1 decelerates, the motor 3 converts the rotational energy from the drive shaft 4 to electric power using regenerative torque to produce regenerative power.

The battery array 10 includes one or more first batteries 11 including one or more lithium-ion batteries. In the present embodiment, the first batteries 11 include a first lithium-ion battery 11a and a second lithium-ion battery 11b.

The first lithium-ion battery 11a and the second lithium-ion battery 11b are electrically connected in parallel to the motor 3. The first lithium-ion battery 11a and the second lithium-ion battery 11b supply electric power to the motor 3 or store electric power supplied from the motor 3 or from an external source.

The controller 100 includes, for example, an electronic control unit (ECU) that controls the motor 3. The controller 100 is electrically connected to the battery array 10. The controller 100 operates on electric power from the battery array 10. The controller 100 controls the motor 3 in response to a signal from the battery array 10. In FIG. 1, power lines are indicated by arrows with solid lines, and a signal line is indicated by an arrow with a dotted line.

The controller 100 determines the number of first batteries 11 installed in the electric vehicle 1 and changes the control over the motor 3 based on the determined number. For the electric vehicle 1 having two sets of battery specifications, or more specifically, the specifications defining a first battery 11 and the specifications defining a second battery 12, the controller 100 further determines the battery type to be the first battery 11 or the second battery 12, and changes the control over the motor 3 based on the determined battery type. The second battery 12 may include a lead-acid battery.

In FIG. 1, the second battery 12 is indicated by a two-dot chain line. When the electric vehicle 1 has the second battery 12 installed in place of the first batteries 11, the second battery 12 is electrically connected to the motor 3 in place of the first batteries 11. The second battery 12 then supplies electric power to the motor 3 or stores electric power received from the motor 3 or from an external source.

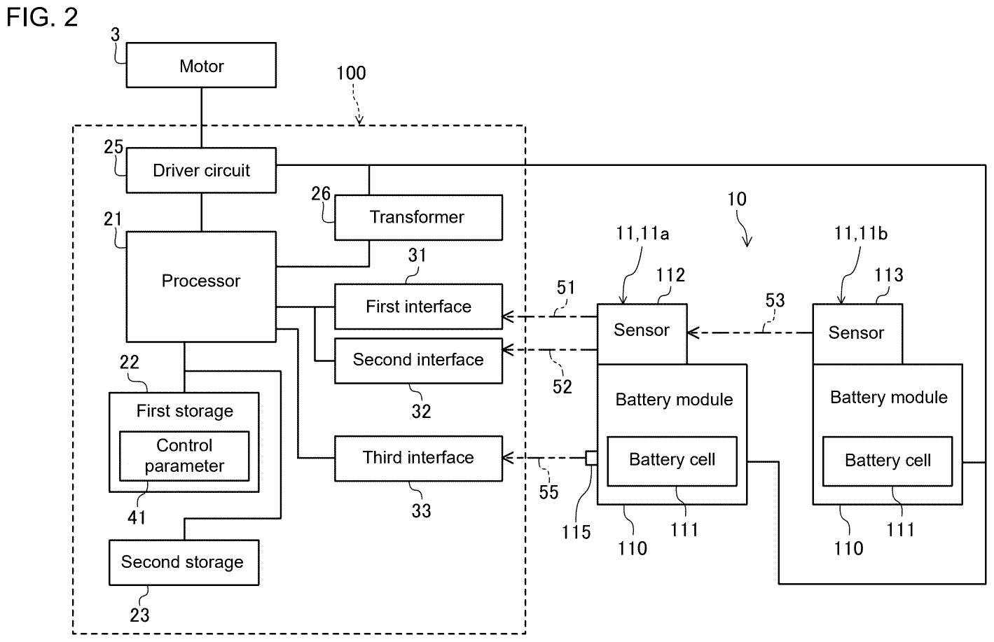

FIG. 2 is a block diagram of the controller 100, the first batteries 11, and the motor 3. The controller 100 includes a processor 21. The controller 100 further includes a first storage 22 and a second storage 23. The controller 100 further includes a first interface 31, a second interface 32, and a third interface 33. The controller 100 further includes a driver circuit 25 and a transformer 26.

The processor 21 performs various arithmetic operations. The processor 21 includes, for example, a circuit such as a central processing unit (CPU). The processor 21 may include a microcontroller unit (MCU), a microprocessor unit (MPU), a field-programmable gate array (FPGA), a programmable logic controller (PLC), or a system large-scale integrated (LSI) circuit. The first interface 31, the second interface 32, and the third interface 33 are electrically connected to the processor 21. The motor 3 is electrically connected to the processor 21 through the driver circuit 25. The transformer 26 transforms an output voltage from one of the first batteries 11 or an output voltage from the second battery 12 to a lower voltage intended for an operation of the processor 21 and outputs the voltage to the processor 21.

The processor 21 determines the number of first batteries 11 and changes the control over the motor 3 based on the determined number. The processor 21 further determines the battery type to be the first battery 11 or the second battery 12 and changes the control over the motor 3 based on the determined battery type.

The first storage 22 stores various programs executable by the processor 21 and various sets of data. The first storage 22 includes a nonvolatile memory, a hard disk drive (HDD), or a solid state drive (SSD). The first storage 22 stores a control program. The first storage 22 stores control parameters 41 for the motor 3. The first storage 22 is electrically connected to the processor 21. The first storage 22 receives electric power from, for example, the processor 21 or the transformer 26.

The second storage 23 temporarily stores data and other information. For example, the second storage 23 includes a volatile memory. The second storage 23 is electrically connected to the processor 21. The second storage 23 receives electric power from, for example, the processor 21 or the transformer 26.

The first interface 31 receives, from one of the first batteries 11, input of a first communication signal 51 carrying information indicating the number of first batteries 11. More specifically, the first interface 31 receives the first communication signal 51 transmitted from the first lithium-ion battery 11a.

The second interface 32 receives, from one of the first batteries 11, input of a second communication signal 52 carrying information indicating the battery type as the first battery 11. More specifically, the second interface 32 receives the second communication signal 52 transmitted from the first lithium-ion battery 11a.

The third interface 33 receives input of a voltage signal 55 output from one of the first batteries 11. More specifically, the third interface 33 receives the voltage signal 55 output from the first lithium-ion battery 11a.

The driver circuit 25 is electrically connected to the motor 3. The driver circuit 25 includes, for example, an inverter. The processor 21 is electrically connected to the driver circuit 25 and controls the motor 3 by controlling the driver circuit 25. The motor 3 is electrically connected to the battery array 10 through the driver circuit 25.

The first lithium-ion battery 11a includes a battery module 110 and a battery-state sensor 112. The battery-state sensor 112 is hereafter also simply referred to as the sensor 112.

The battery module 110 includes one or more battery cells 111. Each battery cell 111 includes an anode plate, a cathode plate, and a separator between the anode plate and the cathode plate. In the battery module 110 including multiple battery cells 111, the battery cells 111 are connected in series in an example. In another example, the battery cells 111 are connected in parallel. In still another example, the battery cells 111 include battery cells 111 that are connected in series and battery cells 111 that are connected in parallel. The battery module 110 outputs the voltage signal 55 to the third interface 33.

The sensor 112 is attached to the battery module 110. The sensor 112 includes, for example, a battery management unit (BMU). The sensor 112 detects the state of the first lithium-ion battery 11a. More specifically, the sensor 112 detects the number of other lithium-ion batteries 11 connected to the first lithium-ion battery 11a and also identifies the battery type of the first lithium-ion battery 11a.

The sensor 112 may include a voltage sensor that detects the voltage of the first lithium-ion battery 11a or may include a temperature sensor that detects the temperature of the first lithium-ion battery 11a. The sensor 112 may detect, for example, overcharging or overdischarging of the first lithium-ion battery 11a during charging or discharging based on the voltage detected by the voltage sensor. The sensor 112 may detect overheating or a low-temperature state of the first lithium-ion battery 11a during charging or discharging based on the temperature detected by the temperature sensor. The lithium-ion battery 11 may include a memory storing information indicating the battery type of the first lithium-ion battery 11a. The sensor 112 may read information indicating the battery type of the first lithium-ion battery 11a stored in the memory.

The sensor 112 transmits the first communication signal 51 to the first interface 31, and transmits the second communication signal 52 to the second interface 32. The first communication signal 51 and the second communication signal 52 are transmitted through, for example, a controller area network (CAN). The first interface 31 and the second interface 32 each include, for example, a connector for the CAN. The sensor 112 is connected to the first interface 31 and the second interface 32 with an electric cable. The sensor 112 may be connected to the first interface 31 and the second interface 32 with a wireless communication device.

The second lithium-ion battery 11b has the same structure as the first lithium-ion battery 11a. The components of the second lithium-ion battery 11b that are the same as the components of the first lithium-ion battery 11a are denoted with the same reference numerals as those components. More specifically, the second lithium-ion battery 11b includes a battery module 110 and a battery-state sensor 113. The battery-state sensor 113 is hereafter also simply referred to as the sensor 113. The sensor 113 includes, for example, a BMU. The sensor 113 transmits a third communication signal 53 indicating the battery type of the second lithium-ion battery 11b to the sensor 112 included in the first lithium-ion battery 11a.

The first communication signal 51 carries information indicating the number of first batteries 11. In the example shown in FIG. 2, the battery array 10 includes two first batteries 11. The sensor 112 included in the first lithium-ion battery 11a receives the third communication signal 53 to detect the number of first batteries 11 connected to the first lithium-ion battery 11a, and transmits, to the first interface 31, a first communication signal 51 indicating the number of first batteries 11 obtained by adding the first battery 11 including the sensor 112 to the detected number.

The second communication signal 52 carries information indicating the battery type as the first battery 11. The sensor 112 included in the first lithium-ion battery 11a transmits, to the second interface 32, the second communication signal 52 carrying information including, in addition to the battery type of the first lithium-ion battery 11a, the battery type of the second lithium-ion battery 11b included in the third communication signal 53. When the first lithium-ion battery 11a is of the same battery type as the second lithium-ion battery 11b, the sensor 112 may transmit, to the second interface 32, the second communication signal 52 carrying information indicating the battery type of the first lithium-ion battery 11a.

The first lithium-ion battery 11a further includes an output port 115 for outputting the voltage signal 55. The output port 115 is included in the battery module 110. The output port 115 may be included in the sensor 112. The voltage signal 55 is, for example, represented by a high-level voltage and is a digital signal indicating 1. When the output port 115 of the first lithium-ion battery 11a is electrically connected to the third interface 33 either directly or by wiring, the voltage signal 55 is input into the third interface 33.

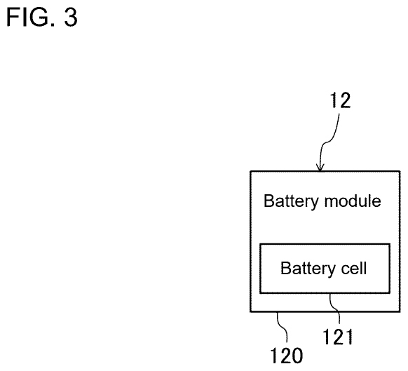

FIG. 3 is a block diagram of the second battery 12. The second battery 12 includes a battery module 120. The second battery 12 is free from a sensor corresponding to the sensor 112 in the lithium-ion battery 11 and free from an output port corresponding to the output port 115. The battery module 120 includes one or more battery cells 121. Each battery cell 121 includes an anode plate, a cathode plate, and a separator between the anode plate and the cathode plate. In the battery module 120 including multiple battery cells 121, the battery cells 121 are connected in series in an example. In another example, the battery cells 121 are connected in parallel. In still another example, the battery cells 121 include battery cells 121 that are connected in series and battery cells 121 that are connected in parallel.

When the electric vehicle 1 has the second battery 12 installed in place of the first batteries 11, no voltage signal 55 is input into the third interface 33. The second battery 12 is free from the sensor 112. Thus, no second communication signal 52 is input into the first interface 31 or the second interface 32.

The processing performed by the processor 21 will now be described. The processor 21 loads the control program from the first storage 22 into the second storage 23 and executes the control program.

The processor 21 determines the battery type to be the first battery 11 or the second battery 12. The processor 21 changes the control over the motor 3 based on the determined battery type. When the battery type is determined to be the first battery 11, the processor 21 determines the number of first batteries 11.

More specifically, the processor 21 determines the number of first batteries 11 based on the first communication signal 51 input into the first interface 31. The processor 21 changes the control over the motor 3 that is electrically connected to the first batteries 11 based on the determined number. The control over the motor 3 includes control over the output of the motor 3.

The processor 21 determines the battery type based on the second communication signal 52 input into the second interface 32 and the voltage signal 55 input into the third interface 33. When the second communication signal 52 is input into the second interface 32 and the voltage signal 55 is input into the third interface 33 during an operation of the processor 21, the processor 21 determines the battery type to be the first battery 11. When no second communication signal 52 is input into the second interface 32 and no voltage signal 55 is input into the third interface 33 during an operation of the processor 21, the processor 21 determines the battery type to be the second battery 12.

The processor 21 may detect an error when the second communication signal 52 is input into the second interface 32 and no voltage signal 55 is input into the third interface 33 during an operation of the processor 21. The processor 21 may detect an error when no second communication signal 52 is input into the second interface 32 and the voltage signal 55 is input into the third interface 33 during an operation of the processor 21. When detecting an error, the processor 21 maintains the control that has been set over the motor 3. The processor 21 may output a notification signal to notify an operator of the error detection with an output device outputting, for example, a sound, light, or a text for display.

The processor 21 changes the control over the motor 3 based on the control parameters 41 stored in the first storage 22. The control parameters 41 include a current-regulating parameter in a driving mode of the motor 3 and a current-regulating parameter in a regeneration mode of the motor 3. The current-regulating parameter in the driving mode of the motor 3 is hereafter referred to as the current parameter in the driving mode. The current-regulating parameter in the regeneration mode of the motor 3 is hereafter referred to as the current parameter in the regeneration mode. Once the control over the motor 3 is changed, the processor 21 performs the control over the motor 3 until, for example, the control over the motor 3 is changed subsequently. The processor 21 may reset the control over the motor 3 when, for example, the power supply is stopped or is reset. Once the control over the motor 3 is reset, the processor 21 keeps the motor 3 undriven until, for example, the control over the motor 3 is changed subsequently.

The current parameter in the driving mode is defined based on the relationship between the upper limit of the current in the driving mode of the motor 3, the number of first batteries 11, and the battery type to be the first battery 11 or the second battery 12. The number of first batteries 11 is hereafter referred to as the battery number. The battery type to be the first battery 11 or the second battery 12 is hereafter referred to as the battery type. The current parameter in the regeneration mode is defined based on the relationship between the upper limit of the current in the regeneration mode of the motor 3, the battery number, and the battery type.

For the control parameter 41 being the current parameter in the driving mode, the processor 21 changes the upper limit of the current in the driving mode of the motor 3 based on the battery number and the battery type. For more first batteries 11 to be used, the processor 21 increases the maximum current in the driving mode. More specifically, the processor 21 controls the motor to satisfy A1<A2, where A1 is the upper limit of the current in the driving mode to be used by one first battery 11 being connected, and A2 is the upper limit of the current in the driving mode to be used by multiple first batteries 11 being connected. For example, A2 is the upper limit of the current in the driving mode to be used by two first batteries 11 being connected.

For the control parameter 41 being the current parameter in the regeneration mode, the processor 21 changes the upper limit of the current in the regeneration mode of the motor 3 based on the battery number and the battery type. For more first batteries 11 to be used, the processor 21 increases the maximum current in the regeneration mode. More specifically, the processor 21 controls the motor to satisfy B1<B2, where B1 is the upper limit of the current in the regeneration mode to be used by one first battery 11 being connected, and B2 is the upper limit of the current in the regeneration mode to be used by multiple first batteries 11 being connected. For example, B2 is the upper limit of the current in the regeneration mode to be used by two first batteries 11 being connected.

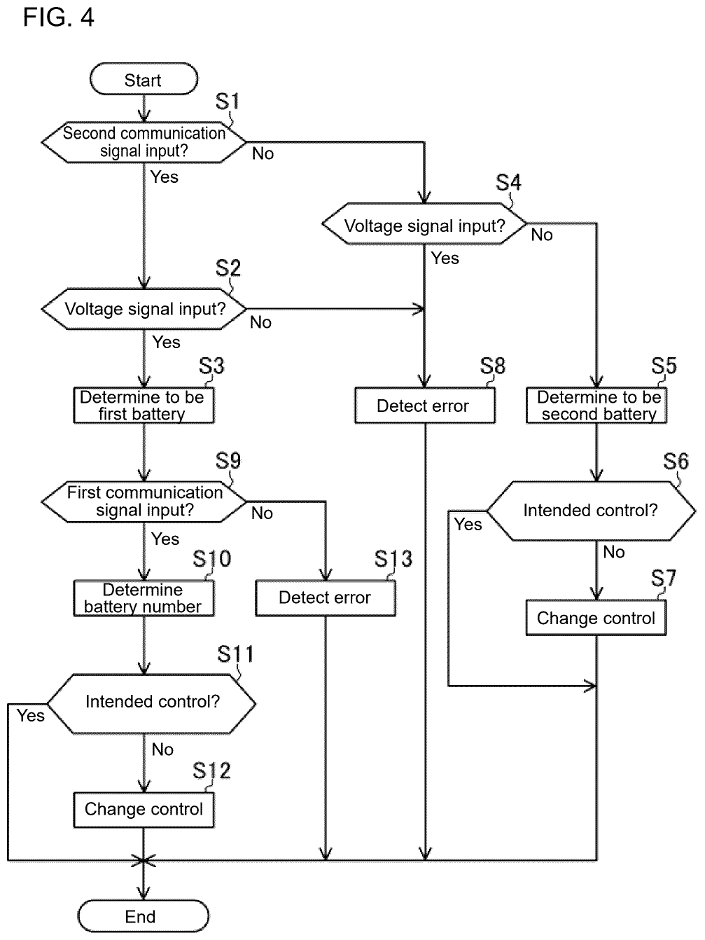

The processing performed by the controller 100 will now be described with reference to a flowchart. The processing performed by the controller 100 is an example of a method for controlling an electric vehicle. FIG. 4 is a flowchart of the processing performed by the controller 100. Once the controller 100 starts receiving electric power that activates the processor 21, the processor 21 starts the processing in step S1 and subsequent steps. Once the processing in the flowchart is complete, the processor 21 may repeat the processing in step S1 and subsequent steps after a predetermined time period until the electric power to the controller 100 is stopped.

In step S1, the processor 21 determines whether a second communication signal 52 has been input into the second interface 32.

When determining that a second communication signal 52 has been input into the second interface 32 in step S1, the processor 21 determines whether a voltage signal 55 has been input into the third interface 33 in step S2.

When determining that a voltage signal 55 has been input into the third interface 33 in step S2, the processor 21 determines the battery type to be the first battery 11 in step S3.

When determining that no second communication signal 52 has been input into the second interface 32 in step S1, the processor 21 determines whether a voltage signal 55 has been input into the third interface 33 in step S4.

When determining that no voltage signal 55 has been input into the third interface 33 in step S4, the processor 21 determines the battery type to be the second battery 12 in step S5. In step S6, the processor 21 determines whether the control being performed over the motor 3 is the control intended for the second battery 12.

When determining that the control being performed over the motor 3 is not the control intended for the second battery 12 in step S6, the processor 21 changes the control over the motor 3 to the control intended for the second battery 12 in step S7 and ends the process. The processor 21 ends the process when determining that the control being performed over the motor 3 is the control intended for the second battery 12 in step S6.

When determining that a voltage signal 55 has been input into the third interface 33 in step S4, the processor 21 detects an error in step S8 and ends the process.

When determining the battery type to be the first battery 11 in step S3, the processor 21 determines whether a first communication signal 51 has been input into the first interface 31 in step S9.

When determining that a first communication signal 51 has been input into the first interface 31 in step S9, the processor 21 determines the number of first batteries 11 in step S10. In step S11, the processor 21 determines whether the control being performed over the motor 3 is the control intended for the number of first batteries 11 determined in step S10.

When determining, in step S11, that the control being performed over the motor 3 is not the control intended for the number of first batteries 11 determined in step S10, the processor 21 changes the control over the motor 3 based on the number of first batteries 11 in step S12 and ends the process. When determining, in step S11, that the control being performed over the motor 3 is the control intended for the number of first batteries 11 determined in step S10, the processor 21 ends the process.

When determining that no first communication signal 51 has been input into the first interface 31 in step S9, the processor 21 detects an error in step S13.

The controller 100 for an electric vehicle includes the processor 21 that determines the number of first batteries 11 and changes the control over the motor 3 based on the determined number, and thus automatically changes the control over the motor 3 based on the number of first batteries 11. The controller 100 can thus perform control over the motor 3 responsive to the number of first batteries 11.

The controller 100 can perform appropriate control over the motor 3 based on the number of first batteries 11, and is thus usable commonly for multiple electric vehicles 1 that differ in the specifications defining the numbers of batteries to be installed. The controller 100 can perform appropriate control over the motor 3 based on the number of first batteries 11, and thus can perform appropriate control over the motor 3 independently of, for example, any error in the number of first batteries 11 installed in the electric vehicle 1.

The processor 21 determines the battery number based on the first communication signal 51 input into the first interface 31. The sensor 112 may be, for example, a BMU preinstalled in the first battery 11 to transmit the first communication signal 51 carrying information indicating the battery number.

The processor 21 further determines the battery type to be the first battery 11 or the second battery 12 and changes the control over the motor 3 based on the determined battery type. The controller 100 can thus perform control over the motor 3 responsive further to the battery type.

An electric vehicle 1 having two sets of specifications defining, for example, the battery type being the first battery 11 and the battery type being the second battery 12, has controllers usable for the respective sets of specifications. The operator thus selectively installs the controller corresponding to the intended set of specifications. However, selectively installing the controller for the intended set of specifications in the electric vehicle is time-consuming. In contrast, the controller 100 for an electric vehicle according to one or more embodiments of the present disclosure determines the battery type to be the first battery 11 or the second battery 12 and changes the control over the motor 3 based on the determined type to eliminate the time-consuming operation.

When determining the battery type to be the first battery 11, the processor 21 determines the number of first batteries 11. The processor 21 can thus determine the battery type and the battery number efficiently.

The processor 21 determines the battery type based on the second communication signal 52 input into the second interface 32 and the voltage signal 55 input into the third interface 33. The processor 21 can determine the battery type more accurately using these two different signals.

The processor 21 determines the battery type to be the first battery 11 when the communication signal is input into the second interface 32 and the voltage signal is input into the third interface 33, and determines the battery type to be the second battery 12 when no communication signal is input into the second interface 32 and no voltage signal is input into the third interface 33. The processor 21 can determine the battery type more accurately using these two different signals.

The processor 21 changes the control over the motor 3 based on a control parameter 41 stored in the first storage 22. The controller 100 can thus control the motor 3 efficiently. For example, the processor 21 can easily change the control over the motor 3 by limiting a control parameter 41 to be used or by selecting the control parameter 41 to be used.

The method for controlling an electric vehicle includes determining the number of first batteries 11 and changing the control over the motor 3 based on the determined number. This method automatically changes the control over the motor 3 based on the number of first batteries 11 to allow control over the motor 3 responsive to the number of first batteries 11.

### Other Embodiments

Although the above embodiments are described based on exemplary techniques according to one or more embodiments of the disclosure of the present application, such techniques according to one or more embodiments of the present disclosure are not limited to those described in the above embodiments and may be modified, substituted, added, or eliminated as appropriate. The components described in the above embodiments may be combined with one another in other embodiments. The components described with reference to the accompanying drawings and in the detailed description of the embodiments may include not merely those that are essential for solving the issue but also those that are not essential for solving the issue for illustrating the techniques. Thus, the components that are included in the accompanying drawings or the detailed description but are not essential for solving the issue should not be identified readily as being essential for solving the issue.

Although the electric vehicle 1 is an electric automobile in the above embodiments, the electric vehicle 1 may be a hybrid automobile that combines the motor 3 with an engine that is an internal combustion engine.

Although the motor 3 functions as an electric motor and as a power generator in the above embodiments, the motor 3 may simply function as an electric motor. In this structure, a first battery 11 does not receive electric power from the motor 3 and simply supplies electric power to the motor 3.

Although the battery array 10 includes two first batteries 11 in the above embodiments, the battery array 10 may include one first battery 11, or three or more first batteries 11. When the battery array 10 includes three or more first batteries 11, the sensor 113 included in each of the first lithium-ion batteries 11 excluding the first lithium-ion battery 11a may separately transmit a signal to the sensor 112 included in the first lithium-ion battery 11a connected to the controller 100. When the battery array 10 includes three or more lithium-ion batteries 11, the sensor 113 included in each of the lithium-ion batteries 11 excluding the first lithium-ion battery 11a may transmit a signal in series to cause the signal to be finally transmitted to the sensor 112 included in the first lithium-ion battery 11a.

Although the processor 21 determines the battery type to be the first battery 11 or the second battery 12 and changes the control over the motor 3 based on the determined battery type in the above embodiments, the processor 21 may not determine the battery type to be the first battery 11 or the second battery 12. More specifically, the processor 21 may simply determine the number of first batteries 11 and change the control over the motor 3 based on the determined number.

Although the first interface 31 is an interface separate from the second interface 32 in the above embodiments, the first interface 31 may be a common interface that also functions as the second interface 32. In this structure, the wire for carrying the first communication signal 51 may be a common wire that also carries the second communication signal 52 or may be a wire separate from the wire for carrying the second communication signal 52.

Although the third interface 33 is an interface separate from the first interface 31 and the second interface 32 in the above embodiments, the third interface 33 may be a common interface that also functions as the first interface 31 and the second interface 32. In this structure, the wire for carrying the voltage signal 55 may be a wire separate from the wire for carrying the first communication signal 51 and from the wire for carrying the second communication signal 52.

Although the first batteries include lithium-ion batteries in the above embodiments, the battery type to be the first battery may be other than a lithium-ion battery. Although the second battery includes a lead-acid battery in the above embodiments, the battery type to be the second battery may be other than a lead-acid battery. The first batteries may be any batteries including a BMU. The first batteries may include sodium-ion batteries, fluoride-ion batteries, or magnesium-ion batteries. The second battery may be any battery that underperforms the first batteries.

The flowchart in FIG. 4 is a mere example. The steps in the flowchart shown in FIG. 4 may be changed or replaced with other steps, or may have one or more steps added or eliminated. The steps in the flowchart shown in FIG. 4 may be performed in a different order, or the processes performed in series may instead be performed in parallel. In the flowchart shown in FIG. 4, for example, the determination about the voltage signal in step S2 may be performed either before or in parallel with the determination about the second communication signal in step S1. When the determination about the second communication signal in step S1 is replaced with the determination about the voltage signal in step S2, the determination about the voltage signal in step S4 is replaced with the determination about the second communication signal. In some embodiments, steps S1 to S8 may be eliminated.

In the above embodiments, the motor 3 may be replaced with an electrical device. The electrical device includes a display. The processor 21 changes the control over the electrical device based on the determined battery number. More specifically, the processor 21 changes the information appearing on the display. The processor 21 changes the information appearing on the display based on the determined battery number. The processor 21 may change the information appearing on the display based on the determined battery number and the determined battery type. The display shows information associated with one or more first batteries.

The processor 21 causes, for example, the display to show information indicating the number of first batteries being connected. The processor 21 causes, for example, the display to show information indicating the battery type of one or more batteries being connected. The electrical device may further include the motor 3, in addition to the display. Examples of the display include an instrument panel, a liquid crystal display, and an organic electroluminescent (EL) display. The display showing information indicating the number of batteries connected to the display can inform the user of the number of batteries connected to the display. The display showing information indicating the battery type of one or more batteries being connected can inform the user of the battery type of one or more batteries connected to the display.

The method for controlling an electric vehicle is implementable by an apparatus other than the controller 100 for an electric vehicle described above.

The functions implementable by the components described herein may be implementable by circuitry or processing circuitry including a general-purpose processor, a special-purpose processor, an integrated circuit, an application-specific integrated circuit (ASIC), a central processing unit (CPU), a known circuit, or a combination of any of these circuits that are programmed to implement the functions described herein. The processor includes a transistor and another circuit and may be a circuit or an arithmetic circuit. The processor may be a programmable processor that executes a program stored in a memory.

Any circuitry, units, and means herein are hardware programmed to implement the functions described herein or hardware that performs these functions. The hardware may be any hardware described herein or any hardware programmed to implement the functions described herein or any hardware known to implement these functions.

When the hardware is a processor that is one type of circuitry, the circuitry, means, or units may be a combination of hardware and software that serves as either the hardware or the processor, or both.

### ASPECTS

The embodiments described above are examples of the aspects below.

### Aspect 1

A controller 100 for an electric vehicle according to aspect 1 includes a processor 21 that determines a number of one or more first batteries 11 and changes control over a motor 3 electrically connected to the one or more first batteries 11 based on the determined number.

The controller 100 for an electric vehicle according to aspect 1 includes the processor 21 that determines the number of first batteries 11 and automatically changes the control over the motor 3 based on the determined number, thus allowing control over the motor 3 responsive to the number of first batteries 11.

### Aspect 2

A controller 100 for an electric vehicle according to aspect 2 is the controller 100 according to aspect 1 further including a first interface 31 that receives, from a first battery 11 of the one or more first batteries 11, input of a first communication signal 51 carrying information indicating the number, in which the processor 21 determines the number based on the first communication signal 51 input into the first interface 31.

In the controller 100 for an electric vehicle with the structure according to aspect 2, the processor 21 can obtain the information indicating the number of lithium-ion batteries 11 being connected using, for example, a BMU installed in the first battery 11.

### Aspect 3

A controller 100 for an electric vehicle according to aspect 3 is the controller 100 according to aspect 1 or aspect 2, in which the processor 21 determines a battery type to be a first battery 11 of the one or more first batteries 11 or a second battery 12, and changes the control over the motor 3 based on the determined battery type.

The controller 100 for an electric vehicle according to aspect 3 performs control over the motor 3 responsive further to the battery type.

### Aspect 4

A controller 100 for an electric vehicle according to aspect 4 is the controller 100 according to any one of aspects 1 to 3, in which the processor 21 determines the number when determining the battery type to be the first battery 11.

The controller 100 for an electric vehicle according to aspect 4 can determine the battery type and the number efficiently.

### Aspect 5

A controller 100 for an electric vehicle according to aspect 5 is the controller 100 according to any one of aspects 1 to 4, further including a second interface 32 that receives, from a first battery 11 of the one or more first batteries 11, input of a second communication signal 52 carrying information indicating a battery type to be the first battery 11, and a third interface 33 that receives input of a voltage signal 55 output from a first battery 11 of the one or more first batteries 11, in which the processor 21 determines the battery type based on the second communication signal 52 input into the second interface 32 and the voltage signal 55 input into the third interface 33.

The controller 100 for an electric vehicle according to aspect 5 can determine the battery type more accurately.

### Aspect 6

A controller 100 for an electric vehicle according to aspect 6 is the controller 100 according to any one of aspects 1 to 5, in which the processor 21 determines the battery type to be the first battery 11 when the second communication signal 52 is input into the second interface 32 and the voltage signal 55 is input into the third interface 33, and determines the battery type to be the second battery 12 when the second communication signal 52 is not input into the second interface 32 and the voltage signal 55 is not input into the third interface 33.

The controller 100 for an electric vehicle according to aspect 6 can determine the battery type still more accurately.

### Aspect 7

A controller 100 for an electric vehicle according to aspect 7 is the controller 100 according to any one of aspects 1 to 6, further including a storage 22 that stores a control parameter 41 for the motor 3, in which the processor 21 changes the control over the motor 3 based on the control parameter 41 stored in the storage 22.

The controller 100 for an electric vehicle according to aspect 7 can control the motor 3 efficiently. For example, the processor 21 can easily change the control over the motor 3 by limiting a control parameter 41 to be used or by selecting the control parameter 41 to be used.

### Aspect 8

A controller 100 for an electric vehicle according to aspect 8 is the controller 100 according to any one of aspects 1 to 7, in which the processor 21 changes the control over the motor 3 by controlling a current.

The controller 100 for an electric vehicle according to aspect 8 can easily change the control over the motor 3 by controlling the current.

### Aspect 9

A controller 100 for an electric vehicle according to aspect 9 is the controller according to any one of aspects 1 to 8, in which the processor 21 increases a maximum current in a driving mode in response to an increase in the number of the one or more first batteries 11.

The controller 100 for an electric vehicle according to aspect 9 can increase the current flowing through the motor to increase the driving force in response to an increase in the number of the one or more first batteries 11.

### Aspect 10

A controller 100 for an electric vehicle according to aspect 10 is the controller according to any one of aspects 1 to 9, in which the processor 21 increases a maximum current in a regeneration mode in response to an increase in the number of the one or more first batteries 11.

The controller 100 for an electric vehicle according to aspect 10 can increase the current flowing through the one or more first batteries 11 to increase the charging amount in response to an increase in the number of the one or more first batteries 11.

### Aspect 11

A controller 100 for an electric vehicle according to aspect 11 is the controller according to any one of aspects 1 to 10, in which the processor 21 controls the motor to satisfy A1 <A2, where A1 is an upper limit of a current in a driving mode when the one or more first batteries being connected is one first battery, and A2 is an upper limit of a current in the driving mode when the one or more first batteries being connected are a plurality of first batteries.

The controller 100 for an electric vehicle according to aspect 11 includes the processor 21 that can perform optimum control both when one first battery is connected and when a plurality of first batteries are connected.

### Aspect 12

A controller 100 for an electric vehicle according to aspect 12 is the controller according to any one of aspects 1 to 11, in which the processor 21 controls the motor to satisfy B1 <B2, where B1 is an upper limit of a current in a regeneration mode when the one or more first batteries being connected is one first battery, and B2 is an upper limit of a current in the regeneration mode when the one or more first batteries being connected are a plurality of first batteries.

The controller 100 for an electric vehicle according to aspect 12 includes the processor 21 that can perform optimum control both when one first battery is connected and when a plurality of first batteries are connected.

### Aspect 13

A controller 100 for an electric vehicle according to aspect 13 is the controller according to any one of aspects 1 to 12, in which the processor 21 changes information appearing on a display based on the determined number.

The controller 100 for an electric vehicle according to aspect 13 includes the processor 21 that determines the number of one or more first batteries 11, and automatically changes the information appearing on the display responsive to the determined number, thus allowing control over the display responsive to the number of the one or more first batteries 11.

### Aspect 14

A controller 100 for an electric vehicle according to aspect 14 includes a processor that determines a number of one or more first batteries being connected. The one or more first batteries each include a battery module and a sensor that detects a state of the battery module and transmits information associated with the battery module to an external unit. The processor determines the number based on the information received from a first battery of the one or more first batteries, and changes control over an electrical device electrically connected to the one or more first batteries based on the determined number.

The controller 100 for an electric vehicle according to aspect 14 includes the processor 21 that determines the number of the one or more first batteries 11, and automatically changes the control over the electrical device based on the number, thus allowing control over the electrical device responsive to the number of the one or more first batteries 11.

### Aspect 15

A controller 100 for an electric vehicle according to aspect 15 is the controller according to aspect 14, in which the electrical device includes a motor that drives the electric vehicle.

The controller 100 for an electric vehicle according to aspect 15 includes the processor 21 that determines the number of the one or more first batteries 11, and automatically changes the control over the motor 3 based on the number, thus allowing control over the motor 3 responsive to the number of the one or more first batteries 11.

### Aspect 16

A controller for an electric vehicle according to aspect 16 is the controller according to aspect 14 or aspect 15, in which the electrical device includes a display that shows information associated with the one or more first batteries.

The controller 100 for an electric vehicle according to aspect 16 includes the processor 21 that determines the number of the one or more first batteries 11, and automatically changes information appearing on the display based on the number, thus allowing control over the display responsive to the number of the one or more first batteries 11.

### Aspect 17

A method for controlling an electric vehicle according to aspect 17 includes determining a number of one or more first batteries 11, and changing control over a motor 3 electrically connected to the one or more first batteries 11 based on the determined number.

The structure according to aspect 17 determines the number of the one or more first batteries 11, and automatically changes the control over the motor 3 based on the determined number, thus allowing control over the motor 3 responsive to the number of the one or more first batteries 11.

What is claimed is:

1. A controller for an electric vehicle, the controller comprising:
a processor configured to determine a number of one or more first batteries, and change control over a motor electrically connected to the one or more first batteries based on the determined number.

2. The controller according to claim 1, further comprising:
a first interface configured to receive, from a first battery of the one or more first batteries, input of a first communication signal carrying information indicating the number,
wherein the processor determines the number based on the first communication signal input into the first interface.

3. The controller according to claim 1, wherein
the processor determines a battery type to be a first battery of the one or more first batteries or a second battery different from the first battery, and changes the control over the motor based on the determined battery type.

4. The controller according to claim 3, wherein
the processor determines the number when determining the battery type to be the first battery.

5. The controller according to claim 3, further comprising:
a second interface configured to receive, from a first battery of the one or more first batteries, input of a second communication signal carrying information indicating a battery type to be the first battery; and
a third interface configured to receive input of a voltage signal output from a first battery of the one or more first batteries,
wherein the processor determines the battery type based on the second communication signal input into the second interface and the voltage signal input into the third interface.

6. The controller according to claim 5, wherein
the processor determines the battery type to be the first battery when the second communication signal is input into the second interface and the voltage signal is input into the third interface, and determines the battery type to be the second battery when the second communication signal is not input into the second interface and the voltage signal is not input into the third interface.

7. The controller according to claim 1, further comprising:
a storage configured to store a control parameter for the motor,
wherein the processor changes the control over the motor based on the control parameter stored in the storage.

8. The controller according to claim 1, wherein the processor changes the control over the motor by controlling a current.

9. The controller according to claim 8, wherein
the processor increases a maximum current in a driving mode in response to an increase in the number of the one or more first batteries.

10. The controller according to claim 8, wherein
the processor increases a maximum current in a regeneration mode in response to an increase in the number of the one or more first batteries.

11. The controller according to claim 8, wherein
the processor controls the motor to satisfy A1 <A2, where A1 is an upper limit of a current in a driving mode when the one or more first batteries being connected is one first battery, and A2 is an upper limit of a current in the driving mode when the one or more first batteries being connected are a plurality of first batteries.

12. The controller according to claim 8, wherein
the processor controls the motor to satisfy B1 <B2, where B1 is an upper limit of a current in a regeneration mode when the one or more first batteries being connected is one first battery, and B2 is an upper limit of a current in the regeneration mode when the one or more first batteries being connected are a plurality of first batteries.

13. The controller according to claim 1, wherein the processor changes information appearing on a display based on the determined number.

14. A controller for an electric vehicle, the controller comprising:
a processor configured to determine a number of one or more first batteries being connected, the one or more first batteries each including a battery module and a sensor configured to detect a state of the battery module and transmit information associated with the battery module to an external unit, the processor being configured to determine the number based on the information received from a first battery of the one or more first batteries, and change control over an electrical device electrically connected to the one or more first batteries based on the determined number.

15. The controller according to claim 14, wherein the electrical device includes a motor configured to drive the electric vehicle.

16. The controller according to claim 14, wherein
the electrical device includes a display configured to show information associated with the one or more first batteries.

17. A method for controlling an electric vehicle, the method comprising:
determining a number of one or more first batteries; and
changing control over a motor electrically connected to the one or more first batteries based on the determined number.
